(19) United States
(12) Patent Application Publication
(10) Pub. No.: US 2024/0040613 A1
(43) Pub. Date: Feb. 1, 2024

(54) UPLINK TRANSMISSION ON A CONTENTION-BASED BANDWIDTH PART

(71) Applicant: Google LLC, Mountain View, CA (US)

(72) Inventors: Jibing WANG, Mountain View, CA (US); Erik STAUFFER, Mountain View, CA (US)

(21) Appl. No.: 18/041,365

(22) PCT Filed: Aug. 10, 2021
(86) PCT No.: PCT/US2021/045328

§ 371 Date: Feb. 10, 2023

Related U.S. Application Data
(60) Provisional application No. 63/063,934, filed on Aug. 10, 2020.

(51) Int. Cl. H04W 74/08; H04W 72/0446; H04W 56/00

(52) U.S. Cl. CPC H04W 74/08; H04W 72/0446; H04W 56/0005

(57) ABSTRACT

A method in a UE for transmitting data via a contention-based BWP in an idle state of a protocol for controlling radio resources can be executed by one or more processors. The method includes determining that the UE has time alignment with a base station for an uplink transmission to the base station (602), determining that a time resource for the uplink transmission is available on the contention-based BWP (604), and transmitting data within the time resource in accordance with the time alignment, while the UE is in the idle state (606).

This disclosure relates generally to wireless communications and, more particularly, to managing transmissions in the uplink direction on a contention-based bandwidth part (BWP).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A 5G New Radio (NR) base station can configure a user device (or user equipment, “UE”) to operate within a certain bandwidth part (BWP), or a portion of a wide carrier bandwidth. The specification 3GPP TS 38.211 version 15.3.0 defines a BWP as a contiguous set of physical resource blocks on a given carrier. As a more specific example, the full carrier bandwidth may be 80 MHz, the UE can be capable of a maximum carrier bandwidth of 20 MHz, and a base station accordingly can configure a 20 MHz BWP for the user device. As another specific example, the full carrier bandwidth may be 200 MHz, the UE may be capable of a maximum carrier bandwidth of 100 MHz, and the base station accordingly can configure a BWP of 100 MHz for the user device.

A base station can allocate certain BWPs for contention-based uplink transmission. The base station can announce the allocation to UEs by transmitting messages of the Radio Resource Control (RRC) protocol or broadcasting the one or more contention-based BWPs in a System Information Block (SIB), for example. The base station in some cases can allocate only some time slots, each including a predefined number of Orthogonal Frequency-Division Multiplexing (OFDM) symbols, for contention-based access. These time slots can have a fixed offset relative to the beginning of a radio frame of a fixed duration, and occur with a certain periodicity. Further, the base station can dynamically change certain parameters of a BWP based on the level of contention in the BWP.

To transmit on a contention-based BWP, a UE obtains from a base station an uplink grant, or a permission to transmit at a certain time. To this end, the UE can perform a random access procedure (RACH), during which the UE first transmits a random access preamble to the base station. This procedure delays the transmission and consumes bandwidth and power. Moreover, this procedure sometimes results in the UE not obtaining an uplink grant and accordingly not gaining access to time resource for uplink transmission because of another device gaining access to the same time resource first, in which the UE can make another attempt to gain access to the BWP at a later time.

### SUMMARY

When a UE of this disclosure has a small amount of data (e.g., less than a certain predetermined threshold amount) to transmit to a base station, the UE transmits the data on a contention-based BWP without first acquiring a UL grant or attempting to acquire the UL grant, when the UE has the time alignment with the base station. The UE can be for example a sensor or a wearable device that reports small amounts of data relatively infrequently.

The UE can determine whether the time alignment with the base station is still valid based on the amount of time elapsed since the UE last acquired a timing advance, e.g., based on whether the timeAlignmentTimer is still running. The UE can perform a listen-before-talk (LBT) procedure or another suitable clear channel assessment (CCA) procedure to determine whether a time resource on the contention-based BWP is available. The time resource can span one or multiple OFDM symbols and need not align with the boundary of a timeslot or a sub-frame.

In addition to the payload, the UE can transmit an identifier of the UE, a modulation and coding scheme (MCS), redundancy information for the data (e.g., whether this is the first transmission or a re-transmission), etc. The base station then can transmit an acknowledgement, e.g., after a certain number of timeslots after the transmission from the UE.

One example embodiment of these techniques is a method in UE for transmitting data via a contention-based BWP in an idle state of a protocol for controlling radio resources. The method can be executed by one or more processors and includes determining that the UE has time alignment with a base station for an uplink transmission to the base station, determining that a time resource for the uplink transmission is available on the contention-based BWP, and transmitting data within the time resource in accordance with the time alignment, while the UE is in the idle state.

Another example embodiment of these techniques is a UE comprising processing hardware and configured to implement the method above.

### BRIEF DESCRIPTION OF THE DRAWINGS

FIG. 1 is a block diagram of an example wireless communication system in which a UE transmits a small amount of data on a contention-based BWP without first acquiring or requesting an uplink grant;

FIG. 2A is a messaging diagram of a known four-step RACH procedure;

FIG. 2B is a messaging diagram of a known two-step RACH procedure;

FIG. 3 is a block diagram of an example time resource during which the UE of FIG. 1 can transmits the data;

FIG. 4 is a flow diagram of an example method for transmitting data on a contention-based BWP using different techniques depending on the size of the transmission, which can be implemented in the UE of s. 1;

FIG. 5 is a flow diagram of an example method for formatting a message for transmission on a contention-based BWP, which can be implemented in the UE of FIG. 1; and

FIG. 6 is a flow diagram of an example method for transmitting data on a contention-based BWP, which can be implemented in the UE of FIG. 1.

### DETAILED DESCRIPTION OF THE DRAWINGS

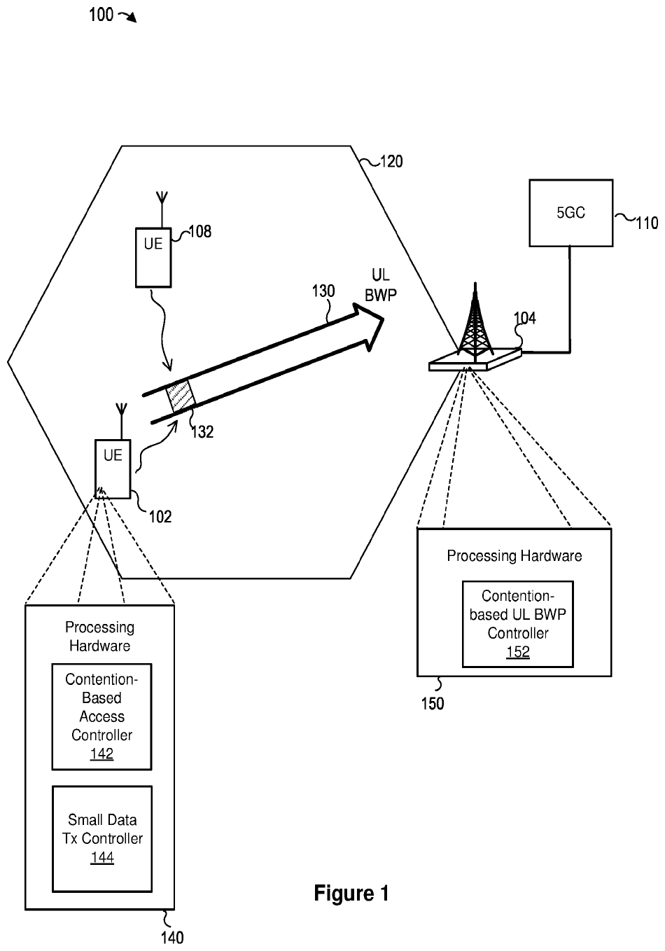

FIG. 1 depicts an example wireless communication system 100 in which a UE 102 can transmit a small amount of data via a contention-based BWP without first attempting to acquire a UL grant.

In addition to the UE 102, the wireless communication system 100 includes a base station 104 connected to a core network (CN) 110, which can be for example a fifth-generation core (5GC), via an NG interface or another suitable link. The 5GC can implement multiple components such as for example a User Plane Function (UPF) configured to transfer user-plane packets related to audio calls, video calls, Internet traffic, etc.; an Access, a Mobility Management (AMF) configured to manage authentication, registration, paging, and other related functions; and a Session Management Function (SMF) configured to manage protocol data unit (PDU) sessions (none shown to avoid clutter). In this example implementation, the base station 104 is a 5G Node B (gNB), but in general the base station 104 can be of any suitable type and can support a radio access technology (RAT) of a type other than NR. The base station 104 supports a cell 120.

The UE 102 can be for example a sensor, a wearable device, or an internet-of-things (IoT) device configured to transmit data relatively infrequently and in small amounts. More generally, the UE 102 can be any device capable of supporting the radio access technology (RAT) of the base station 104.

In operation, the UE 102 operating in the cell 120 can use a time resource 132 transmit data to the base station 104 on a contention-based uplink (UL) BWP 130. Because another device such as a UE 108 can attempt transmissions on the BWP 130 at the same time as the UE 102, the UE 102 can perform a listen-before-talk (LBT) procedure prior to using the time resource 132.

To support this functionality, the UE 102 is equipped processing hardware 140 that can include one or more general-purpose processors (e.g., central processing units (CPUs)) and a non-transitory computer-readable memory storing machine-readable instructions executable on the one or more general-purpose processor(s), and/or special-purpose processing units. The processing hardware 140 in an example implementation includes a contention-based access controller 142 configured to determine when the UE 102 can access a time resource on a contention-based UL BWP, and a small data transmission (Tx) controller 144 configured to determine when the UE 102 should attempt a transmission without acquiring an UL grant.

The base station 104 is equipped processing hardware 140 that also can include one or more general-purpose processors and a non-transitory computer-readable memory storing machine-readable instructions executable on the one or more general-purpose processor(s), and/or special-purpose processing units. The processing hardware 140 implements a contention-based UL BWP controller 152 configured to determine when the UE 102 can transmit small amounts of data on the UL BWP 130.

The base station 104 can dynamically modify the UL BWP 130 in view of the amount of traffic on the UL BWP 130. For example, the base station 104 can increase the width of the UL BWP 130 when a certain number of uplink transmissions occur on the UL BWP 130 during a certain period of time. Although FIG. 1 illustrates a contention-based UL BWP 130, the base station 104 also can support dedicated BWPs for regular UL transmissions. Moreover, the base station 104 in some cases can allocate certain timeslots for contention-based access within another BWP, in which the remaining timeslots conform to another access scheme.

To notify the UE 102, the UE 108, and other devices in the cell 120 of the UL BWP 130, the base station 104 can use announcements in the system information block (SIB) or messages of the Radio Resource Control (RRC) protocol, for example.

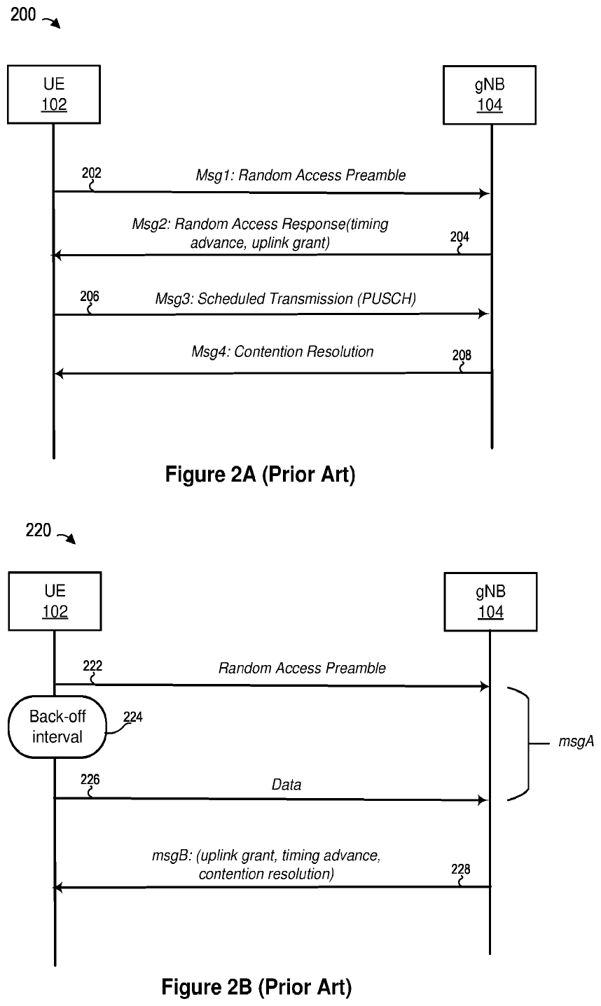

Next, FIG. 2A illustrates a messaging diagram of a known four-step RACH procedure 200. According to the procedure 200, the UE 102 transmits 202 a random access preamble (“Msg1”) to the base station 104. In response, the base station 104 transmits 204 a random access response (RAR or “Msg2”) to the UE 102, which then transmits 206 a scheduled transmission (“Msg3”) to the base station 104. Finally, the base station 104 transmits 208 a contention resolution (“Msg4”) to the UE 102.

Generally speaking, a two-step RACH procedure condenses Msg1 and Msg3 into a first step (“MsgA”) and Msg2 and Msg4 into a second step (“MsgB”). In particular, as illustrated FIG. 2B, the UE 102 transmits 222 a MsgA preamble on a Physical Random Access Channel (PRACH) and transmits 226 MsgA data on a physical uplink shared channel (PUSCH). The MsgA preamble and the MsgA data can be separated by only a back-off interval 224, without requiring any messages from the base station 104. The base station 104 then responds 228 with MsgB that includes an uplink grant, a timing advance, and contention resolution.

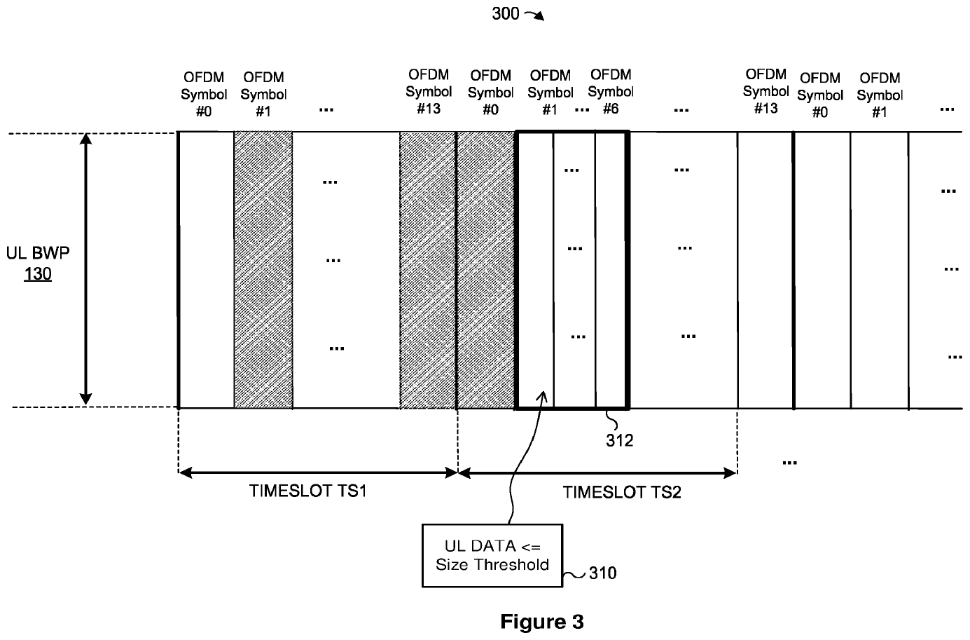

Now referring to FIG. 3, a timing diagram 300 illustrates an example schedule according to which the UE 102 can select a time resource for transmitting a small amount of data. The BWP 130 occupies less than the bandwidth of the carrier of the base station 104. Time resources on the BWP 130 can have the duration of OFDM symbols, with a certain number of consecutive OFDM symbols defining a timeslot. For example, each of timeslots TS₁, TS₂, . . . TS_{N} includes a respective sequence of 14 OFDM symbols (symbol #0, symbol #1, . . . symbol #13). Several timeslots can define a sub-frame, and several sub-frames can make up a single frame.

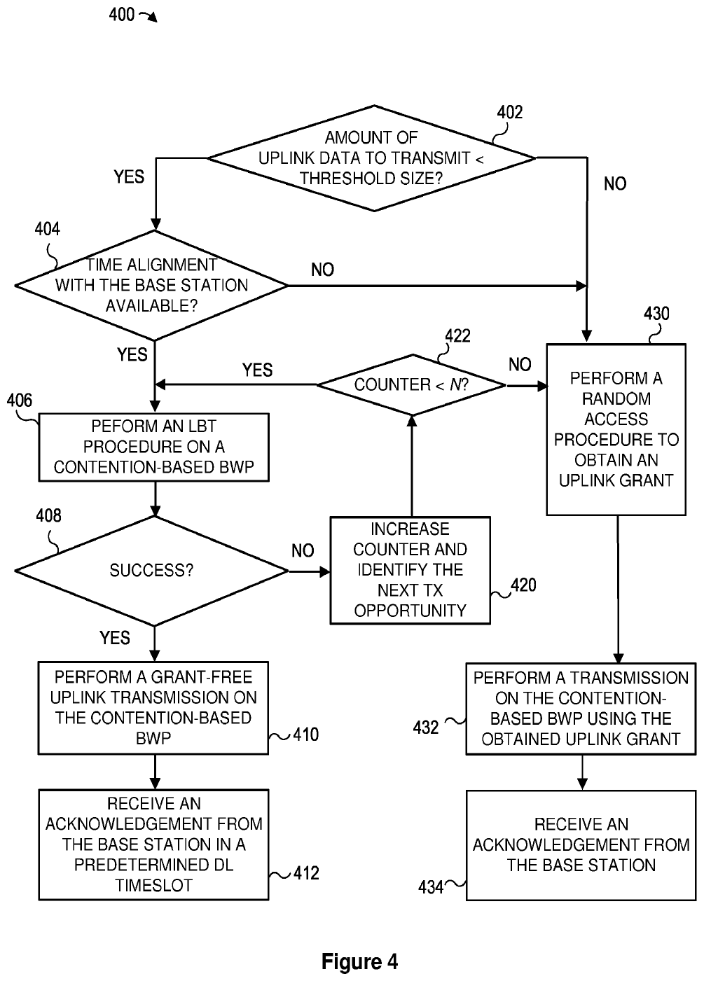

The small data Tx controller 144 of the UE 102 can determine that the size of the UL data is suitable for transmission without requesting an uplink grant. For example, the small data Tx controller 144 can determine that the size of data 310 to be transmitted in the uplink direction is less than a size threshold T_{size} (e.g., 10 bytes, 100 bytes, 1 KB), and the contention-based access controller 142 can determine that the UE 102 has the requisite time alignment with the base station 104, as discussed below with reference to FIG. 4. The contention-based access controller 142 then can perform an LBT procedure and, after determining that a time resource 312 is available, the small data Tx controller 144 and/or the contention-based access controller 142 can cause the UE 102 to transmit the small data. As discussed below, the small data Tx controller 144 also can transmit other information along with the data, such as an identifier of the UE 102 or a modulation scheme.

In this example, the time resource 312 begins at OFDM symbol #1 and spans six consecutive OFDM symbols (#1, #2, . . . #6). In another example, the time resource begins at OFDM symbol #0, i.e., aligns with the boundary of the timeslot TS₂. In general, the time resource need not align with the boundary of a timeslot or a frame, and can span any suitable number of OFDM symbols (or other time units).

Thus, to transmit the data 310 during the time resource 312, the UE 102 need not first obtain an uplink grant in accordance with the procedure of FIG. 2A or attempt to obtain an uplink grant while transmitting data in accordance with the procedure of FIG. 2B.

The techniques the UE 102 can implement to transmit data without obtaining an uplink grant are further discussed with reference to example method of FIG. 4. The method 400 can be implemented for example in the component 142 and/or the component 144 as a set of instructions executable by the processing hardware 140.

The method 400 begins at block 402, where the UE 102 determines whether the amount of data the UE 102 has to transmit exceeds a threshold size value. When the size is less than the threshold value, the flow proceeds to block 404; otherwise, the flow proceeds to block 430. At block 402, the UE 102 can operate in an idle state of a protocol for controlling radio resources (e.g., the IDLE state of the RRC protocol, or RRC_IDLE).

At block 404, the UE 102 determines whether it has time alignment with the base station 104. The UE 102 can base this determination on the amount of time that has elapsed since the UE 102 last received a timing advance from the base station. As discussed above, the UE 102 can receive the timing advance during a random access procedure, for example. As a more specific example, the UE 102 can determine whether the timer timeAlignmentTimer specified by 3GPP TS 38.321 is still running. If the UE 102 determines that time alignment is still available, the flow proceeds to block 406. When the UE 102 determines that timeAlignmentTimer has expired, or that the time alignment is otherwise unavailable, the flow proceeds to block 430.

Next, at block 406, the UE 102 performs an LBT procedure or another suitable CCA procedure on the contention-based UL BWP (e.g., the UL BWP 130 discussed above). Referring back to FIG. 3, the UE 102 can identify the time resource 312 as a resource sufficient for transmitting the small amount of data during the interval. More particularly, the UE 102 can compare the amount of data to be transmitted to the total throughput of the time resource 312, at the modulation and coding scheme the UE 102 can use. The UE 102 may detect that the UL BWP is in use at the beginning of the timeslot but determine that a time resource that does not align with the timeslot boundary is available.

If the UE 102 determines that the LBT procedure completes successfully at block 408, and thus that the UL BWP is available for uplink transmission at this time, the UE at block 410 performs a grant-free uplink transmission on the UL BWP. Otherwise, at block 420, the UE 102 increments a counter that keeps track of LBT attempts and identifies the next potential Tx opportunity. If the UE 102 determines at block 422 that the counter has not yet exceeded a predetermined value N (e.g., 3, 4, 5), the flow returns to block 406. The flow otherwise proceeds to block 430. Thus, if the UE 102 fails to perform contention-based transmission a certain number of times in a row, the UE 102 can resume regular, grant-based UL transmissions.

The UE 102 continues to operate in RRC_IDLE at block 410. Thus, the UE 102 need not transition to the connected state (RRC_CONNECTED) to perform a grant-free transmission on a contention-based BWP. Further, the UE 102 at block 410 neither has an uplink grant nor is in the process of obtaining an uplink grant, unlike the transmission 226 of FIG. 2B for example.

In some implementations, the UE 102 can transmit additional information along with the payload, at block 410. The additional information can include for example the identity of the UE 102, such as the cell Radio Network Temporary Identifier (C-RNTI) or another RNTI. The additional information also can include an indication of the modulation and coding scheme (MCS) the UE 102 used to transmit the payload. The UE 102 can choose the MCS based on measurements of strength and/or quality of DL signals from the base station 104, or based on an explicit command from the base station 104. Further, the additional information can include a redundancy information for the data to indicate whether the UE 102 is transmitting this payload in the first instance or a second or subsequent instance (in other words, whether this is a retransmission of the payload).

The base station 104 in some cases specifies the MCS the UE 102 is to use at block 410. Depending on the implementation, the base station 104 can announce the MCS via a broadcast in the cell 120 or select the MCS specifically for the UE 102. In other implementations, the UE 102 is configured to use a certain MCS for uplink transmissions on a contention-based BWP.

According to some implementations, the UE 102 specifies a redundancy version along as a part of the additional information, along with the MCS. The redundancy version can indicate whether the transmission occurs in a first instance or a second instance.

In one implementation or scenario, the UE 102 transmits data at block 410 on the contention-based UL BWP using open-loop power control. In another implementation or scenario, the UE 102 receives control parameters for contention-based UL transmissions from the base station 104 and applies the control parameters when transmitting data at block 410.

After the UE 102 transmits the data in the grant-free manner at block 410, the UE 102 can receive an acknowledgement from the base station 104 at block 410. The acknowledgement can arrive at a predetermined downlink (DL) timeslot on a downlink channel.

When the UE 102 determines that the size of the data is greater than or equal to the threshold value, the UE 102 at block 430 performs a random access procedure such as the procedure 200 of FIG. 2A or the procedure 220 of FIG. 2B. Next, at block 432, the UE 102 transmits the data in the uplink direction using the uplink grant the UE 102 acquired at block 430.

The UE 102 then receives an acknowledgement from the base station 104 at block 434. The base station 104 can transmit the DL acknowledgement in a predetermined DL timeslot after the time resource 312. For example, the base station 104 can schedule DL acknowledgements to occur N timeslots after the timeslot in which the contention-based UL transmission takes place at block 410. The base station 104 can specify this timing using layer 3 (L3) messages, for example.

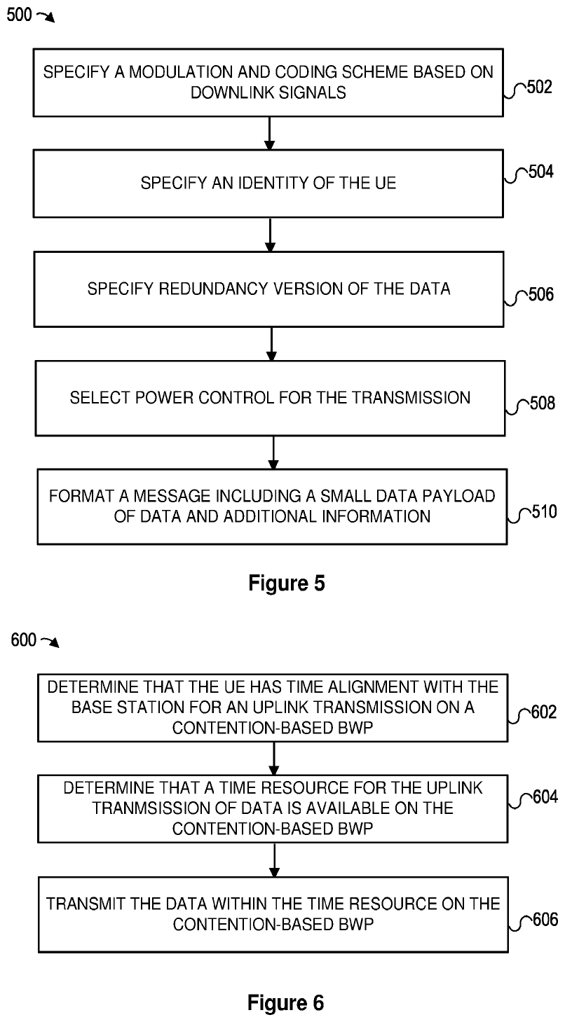

Now referring to FIG. 5, an example method 500 for formatting a message for transmission on a contention-based BWP can be implemented in the UE 102 or another suitable UE. At block 502, the UE 102 select an MCS (e.g., based on DL signals from the base station) and specify the MCS as a part of information accompanying uplink data. Next, at block 504, the UE 102 includes an identity of the UE 102 in the additional information. At block 506, the UE 102 includes redundancy version for the data.

At block 508, the UE 102 selects power control (parameters) for the transmission. At block 510, the UE 102 formats a message or a suitable transmission unit to include the small amount of data along with the additional information, for transmission in the uplink direction on the contention-based BWP. The data can be of a small size not exceeding a predefined threshold, suitable for transmission in a grant-free manner on a contention-based BWP.

Finally, FIG. 6 illustrates an example method 600 for transmitting data on a contention-based BWP, which also can be implemented in the UE 102 or another suitable device. At block 602, the UE 102 determines that it has time alignment with the base station for potential uplink transmission on a contention-based BWP. Next, at block 604, the UE 102 can determine that a time resource for uplink transmission is available on the contention-based BWP. To this end, the UE 102 can use a suitable LBT or another CAA technique. The UE 102 then can format a message or a transmission unit in accordance with the method 500, for example, and transmit the data (and, in some cases, the additional information) on the contention-based BWP at block 606.

The following description may be applied to the description above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.

Example 1. A method for transmitting data via a contention-based BWP in an idle state of a protocol for controlling radio resources is implemented in a UE and executed by processing hardware. The method comprises determining that the UE has time alignment with a base station for an uplink transmission to the base station; determining that a time resource for the uplink transmission is available on the contention-based BWP; and transmitting data within the time resource in accordance with the time alignment, while the UE is in the idle state.

Example 2. The method of example 1, wherein the time resource starts a boundary of an OFDM symbol that does not coincide with a boundary of a timeslot made up of a plurality of OFDM symbols.

Example 3. The method of example 1 or 2, wherein: the transmitting occurs within a subframe of a radio frame of a fixed duration, the subframe including a plurality of OFDM symbols; the method further comprising not transmitting a random access preamble within the radio frame.

Example 4. The method of The method of any of the preceding examples, further comprising selecting the time resource for the uplink transmission in response to determining that a size of the data is below a threshold size.

Example 5. The method of any of the preceding examples, wherein determining that the time resource is available includes performing a listen-before-talk (LBT) procedure.

Example 6. The method of any of the preceding examples, further comprising transmitting, within the time resource, an identifier of the UE.

Example 7. The method of example 6, wherein the identifier is a Cell Radio Network Temporary Identifier (C-RNTI).

Example 8. The method of any of the preceding examples, further comprising: transmitting, within the time resource, an indication of a modulation and encoding scheme (MCS) the UE is using.

Example 9. The method of any of examples 1-8, further comprising: selecting, by the processing hardware, the MCS based on downlink (DL) signal measurements.

Example 10. The method of any of the preceding examples, further comprising: receiving an indication of an MCS to be used in the contention-based BWP; wherein the transmitting conforms to the MCS.

Example 11. The method of any of the preceding examples, further comprising: transmitting, within the time resource, an indication of redundancy version of the data.

Example 12. The method of any of the preceding examples, further comprising: receiving, by the processing hardware from the base station, a power control parameter; wherein the transmitting includes applying the power control parameter.

Example 13. The method of any of examples 1-11, wherein the transmitting includes applying open-loop power control.

Example 14. The method of any of the preceding examples, wherein determining that the UE has time alignment with the base station is based on an amount of time elapsed since the UE last received a timing advance from the base station.

Example 15. The method of any of the preceding examples, wherein: the transmitting occurs in a first instance, the method further comprising, in a second instance: identifying, by the processing hardware and when the UE has time alignment with the base station, a second resource on the contention-based BWP for transmitting second data, and in response to determining that the second resource is unavailable, performing a procedure for obtaining an uplink grant for transmitting the second data on the contention-based BWP.

Example 16. The method of example 15, wherein determining that the second resource is unavailable includes failing an LBT procedure N times, N>=1.

Example 17. The method of any of the preceding examples, further comprising: receiving, by the processing hardware, an acknowledgement for the data from the base station.

Example 18. The method of example 17, including receiving the acknowledgement in a timeslot offset by a fixed interval from a timeslot that includes the time resource.

Example 19. The method of example 18, further comprising: receiving the fixed interval from the base station.

Example 20. A UE comprising processing hardware and configured to implement a method of any of the preceding examples

1. A method of wireless communication performed by a user equipment, UE, the method comprising:
determining that the UE has a time alignment with a base station for an uplink transmission to the base station based on an amount of time elapsed since the UE last received a timing advance from the base stations;
determining that a time resource for the uplink transmission is available on a contention-based bandwidth part, BWP; and
transmitting data within the time resource in accordance with the time alignment, while the UE is in an idle state.

2. The method of claim 1, wherein:
the time resource starts at a first boundary of an Orthogonal Frequency-Division Multiplexing, OFDM, symbol, wherein the first boundary does not coincide with a second boundary of a timeslot made up of a plurality of OFDM symbols.

3. The method of claim 1, wherein:
the transmitting occurs within a subframe of a radio frame of a fixed duration, the subframe including a plurality of OFDM symbols;
the method further comprising:
not transmitting a random access preamble within the radio frame.

4. The method of claim 3, further comprising:
selecting the time resource for the uplink transmission in response to determining that a size of the data is below a threshold size.

5. The method of claim 1, wherein determining that the time resource is available comprises:
performing a listen-before-talk, LBT, procedure.

6. The method of claim 1, further comprising:
receiving an indication of an MCS to be used in the contention-based BWP;
wherein the transmitting conforms to the MCS.

7. (canceled)

8. The method of claim 1, wherein:
the transmitting occurs in a first instance,
the method further comprising, in a second instance:
identifying, when the UE has time alignment with the base station, a second resource on the contention-based BWP for transmitting second data, and
in response to determining that the second resource is unavailable, performing a procedure for obtaining an uplink grant for transmitting the second data.

9. The method of claim 8, wherein determining that the second resource is unavailable comprises failing an LBT procedure N times, N>=1.

10. The method of claim 1, further comprising:
receiving an acknowledgement for the data from the base station.

11. The method of claim 10,
wherein the receiving of the acknowledgement occurs in a timeslot offset by a fixed interval from a timeslot that comprises the time resource.

12. The method of claim 11, further comprising:
receiving an indication of the fixed interval from the base station.

13. The method of claim 1, wherein:
the contention-based BWP is one of a plurality of contention-based BWPs which the base station supports for regular uplink, UL, transmission.

14. The method of claim 1, wherein:
the contention-based BWP is a first contention-based BWP; and
a second contention-based BWP comprises timeslots allocated by the base station for contention-based access.

15. The method of claim 14, wherein the first contention-based BWP and the second contention-based BWP have different access schemes.

16. (canceled)

17. The method of claim 1, further comprising transmitting, within the time resource, an identifier of the UE.

18. The method of claim 17, wherein the identifier is a Cell Radio Network Temporary Identifier, C-RNTI.

19. The method of claim 1, further comprising: transmitting, within the time resource, an indication of a modulation and encoding scheme, MCS, the UE is using.
